(19) United States
(12) Patent Application Publication
(10) Pub. No.: US 2014/0339261 A1
(43) Pub. Date: Nov. 20, 2014

(54) WATER SERVER

(71) Applicant: Yoshinori Orita, Kakogawa (JP)

(72) Inventor: Yoshinori Orita, Kakogawa (JP)

(21) Appl. No.: 14/370,070

(22) PCT Filed: Jul. 2, 2012
(86) PCT No.: PCT/JP2012/066860

§ 371 Date: Jul. 1, 2014

(30) Foreign Application Priority Data
Jan. 6, 2012 (JP) 2012-001291

(51) Int. Cl. B67D 3/00

(52) U.S. Cl. CPC B67D 3/0009; B67D 3/0061
USPC 222/146.6

(57) ABSTRACT

A water server includes a baffle which interferes with the downward flow of water introduced into a cold water tank through a water supply line. The baffle has a water transfer passage is formed by a downwardly recessed surface portion formed on the top surface of the baffle and having a distal edge, and an edge portion having a predetermined thickness and located over the distal edge so as to overlap the distal edge. The water transfer passage is configured such that the recessed surface portion deflects the flow of water flowing down through the water transfer passage in a horizontal direction or a direction close to a horizontal direction. Water is thus discharged from the terminal end opening defined by the distal edge and the edge portion into the lower portion of the cold water tank in a direction close to a horizontal direction.

### TECHNICAL FIELD

This invention relates to a water server which can cool water in a tank and supply the thus cooled water as drinking water.

### BACKGROUND ART

This type of water server is configured such that when water stored in a cold water tank which is capable of cooling water therein runs short, water is automatically supplied into the tank through a water supply line, the water thus supplied is cooled by a heat exchanger mounted to the cold water tank, and cold water in the cold water tank can be discharged into the atmosphere through a cold water discharge line when a user operates a lever or a cock to open a valve. The closer water in the tank is to the bottom of the tank, the colder it is. If the water server is configured such that water introduced into the cold water tank can directly flows down to the bottom of the tank, the not-yet-sufficiently-cooled water is quickly mixed with the well cooled water at the bottom of the tank, warming the water at the bottom of the tank. In order to prevent this, a baffle is usually provided in the cold water tank which interferes with the downward flow of water (see e.g. the below-identified Patent documents 1 to 3).

With this arrangement, a low-temperature water layer which is lower in temperature than water above the baffle is generated in the lower portion of the cold water tank which is within the height range from the bottom of the cold water tank to the outermost circumferential portion of the baffle, from the bottom of the tank. The cold water discharge line is arranged to discharge water forming the low-temperature water layer. If the outermost circumferential portion of the baffle is fitted to the inner wall of the cold water tank or by minimizing the horizontal gap therebetween, it is possible to increase the area of the baffle, which divides the interior of the cold water tank into upper and lower portions, thereby increasing the effect of interfering with the downward flow of water. But in this case, water above the baffle cannot sufficiently smoothly flow through the baffle into the lower portion of the cold water tank. To avoid this problem, the baffle may be formed with water transfer passages at its portion located inwardly of the outermost circumferential portion so that water introduced into the portion of the cold water tank from the water supply line can be fed into the lower portion of the cold water tank through the water transfer passages.

### PRIOR ART DOCUMENTS

### Patent Documents

Patent document 1: JP Patent Publication 2010-52752A (especially FIG. 1)
Patent document 2: JP Patent Publication 2011-102154A (especially FIG. 1)
Patent document 3: JP Patent Publication 2003-12092A (especially FIGS. 1 and 2)

### SUMMARY OF THE INVENTION

### Object of the Invention

The water transfer passages have a terminal end opening which faces vertically downwardly, just like the gap defined between the inner wall of the cold water tank and the outermost circumferential portion of the baffle. Thus water is discharged through the terminal end openings substantially downwardly into the lower portion of the cold water tank. But since it is possible to reduce the momentum of water flowing through the water transfer passages by reducing the sectional areas of the leading end openings of the water transfer passages, it has not been considered a problem to discharge water downwardly from the terminal end openings of the water transfer passages.

However, if the gap between the inner wall of the cold water tank and the outermost circumferential portion of the baffle is eliminated or reduced to a minimum, while ensuring a sufficient flow rate of water through the baffle with a smaller number of water transfer passages, in order to mount the baffle more simply or to simplify the shape of the baffle, it is necessary to increase the sectional area of the respective water transfer passages over the entire length thereof. This increases the momentum of water when discharged downwardly into the lower portion of the cold water tank from the terminal end openings of the water transfer passages. Water discharged from the water transfer passages can thus be more easily mixed into the low-temperature water layer.

An object of the present invention is to make it more difficult for water discharged from the water transfer passages of the baffle to be mixed into the low-temperature water layer.

### Means for Achieving the Object

In order to achieve this object, at least one such water transfer passage is provided which has no portion extending in the vertical direction over the entire vertical length thereof, and is configured such that water is discharged into the lower portion of the cold water tank from the water transfer passage in a horizontal direction or a direction close to a horizontal direction. With this arrangement, since the water transfer passage has no portions extending in the vertical direction over the entire vertical length thereof, water flowing into the water transfer passage cannot flow down through the baffle in a straight line. Thus, even if the sectional area of the leading end opening of the water transfer passage is increased, the area of the surface of the baffle that divides the interior of the cold water tank into upper and lower portions does not decrease. By using the water transfer passage having no portion vertically extending over the entire vertical length thereof, the flow line of water flowing down in the water transfer passage can be bent such that water flows substantially in a horizontal direction by the time water reaches the terminal end opening. By further arranging the terminal end opening so as to face a direction perpendicular to a side view of the baffle, it is possible to discharge water from the terminal end openings of the water transfer passage into the lower portion of the cold water tank in a horizontal direction or a direction close to a horizontal direction. As used herein, “a direction close to a horizontal direction” refers to a direction inclined upwardly or downwardly relative to a horizontal direction by less than 45°. Water discharged from the water transfer passage in a horizontal direction or a direction close to a horizontal direction never flows down in the lower portion of the cold water tank in a straight line, but flows in a horizontal direction too. Thus such water flows a longer distance until it is mixed into the low-temperature water layer generated in the lower portion of the cold water tank from its bottom, so that such water is never easily mixed into the low-temperature water layer.

By providing the baffle with a plurality of such water transfer passages, it is possible to reduce the flow sectional areas of the respective water transfer passages, thereby reducing the momentum of water discharged into the lower portion of the cold water tank.

Preferably, the terminal end openings of the water transfer passages face a single common direction of rotation about a common vertical axis. With this arrangement, masses of water discharged from the respective water transfer passages never collide against each other, and flow down in the lower portion of the cold water tank, while moderately whirling therein. Thus, these masses of water are never easily mixed into the low-temperature water layer.

The at least one water transfer passage or each of the plurality of water transfer passages may comprise a downwardly recessed surface portion formed on the top surface of the baffle and having a distal edge, and an edge portion having a predetermined thickness and located over the distal edge so as to overlap the distal edge. With this arrangement, the recessed surface portion, which has no portion vertically extending over the entire vertical length thereof, deflects the downward flow of water in a horizontal direction or a direction close to a horizontal direction by the time water reaches the terminal end opening defined by the distal edge and the edge portion. Water is thus discharged through the terminal end opening, which opens in a direction perpendicular to a side view of the baffle, into the lower portion h of the cold water tank in a horizontal direction or a direction close to a horizontal direction.

### Advantages of the Invention

According to the present invention, in a water server comprising a cold water tank configured to cool water stored in the cold water tank, a water supply line through which water is supplied into the cold water tank, a cold water discharge line extending from the cold water tank to the atmosphere, and a baffle configured to interfere with the downward flow of water introduced into the cold water tank from the water supply line, wherein the baffle has an outermost circumferential portion, wherein the cold water tank has a lower portion within a height range extending from a bottom of the cold water tank to the outermost circumferential portion, wherein the water server is configured such that a low-temperature water layer is generated in the lower portion of the cold water tank, the low-temperature water layer being lower in temperature than water in the cold water tank above the baffle, and such that water forming the low-temperature water layer is discharged through the cold water discharge line, and wherein the baffle is formed with at least one water transfer passage at a portion of the baffle located inwardly of the outermost circumferential portion such that water introduced into the portion of the cold water tank above the baffle can flow through the water transfer passage into the lower portion of the cold water tank, the water transfer passage has no portion extending in the vertical direction over the entire vertical length thereof, and is configured such that water is discharged into the lower portion of the cold water tank from the water transfer passage in a horizontal direction or a direction close to a horizontal direction. With this arrangement, water discharged into the lower portion of the cold water tank from the water transfer passage of the baffle is never easily mixed into the low-temperature water layer.

### BRIEF DESCRIPTION OF THE DRAWINGS

FIG. 1 schematically shows a water server embodying the present invention in its entirety.

FIG. 2 is an enlarged view of a cold water tank of FIG. 1.

FIG. 3 is a front view of a baffle of the water server of FIG. 1.

FIG. 4 is a top plan view of the baffle of FIG. 3.

FIG. 5 is a side view of the baffle of FIG. 3.

FIG. 6 shows a horizontal section of the inner wall of the cold water tank of this embodiment, and a partial section of the bottom surface of the baffle of FIG. 3.

FIG. 7 is a sectional view taken along line A-A of FIG. 4.

FIG. 8 is a sectional view taken along line B-B of FIG. 4.

FIG. 9 schematically shows a flow line of water flowing in a water transfer passage of FIG. 3, when taken along a vertical plane.

### BEST MODE FOR EMBODYING THE INVENTION

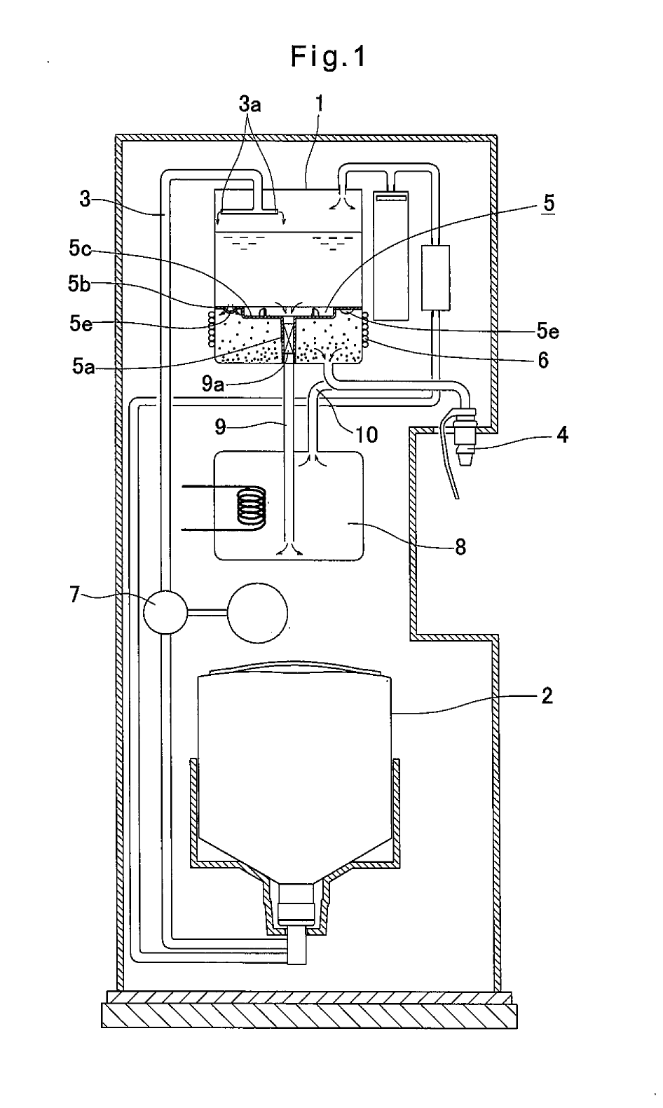

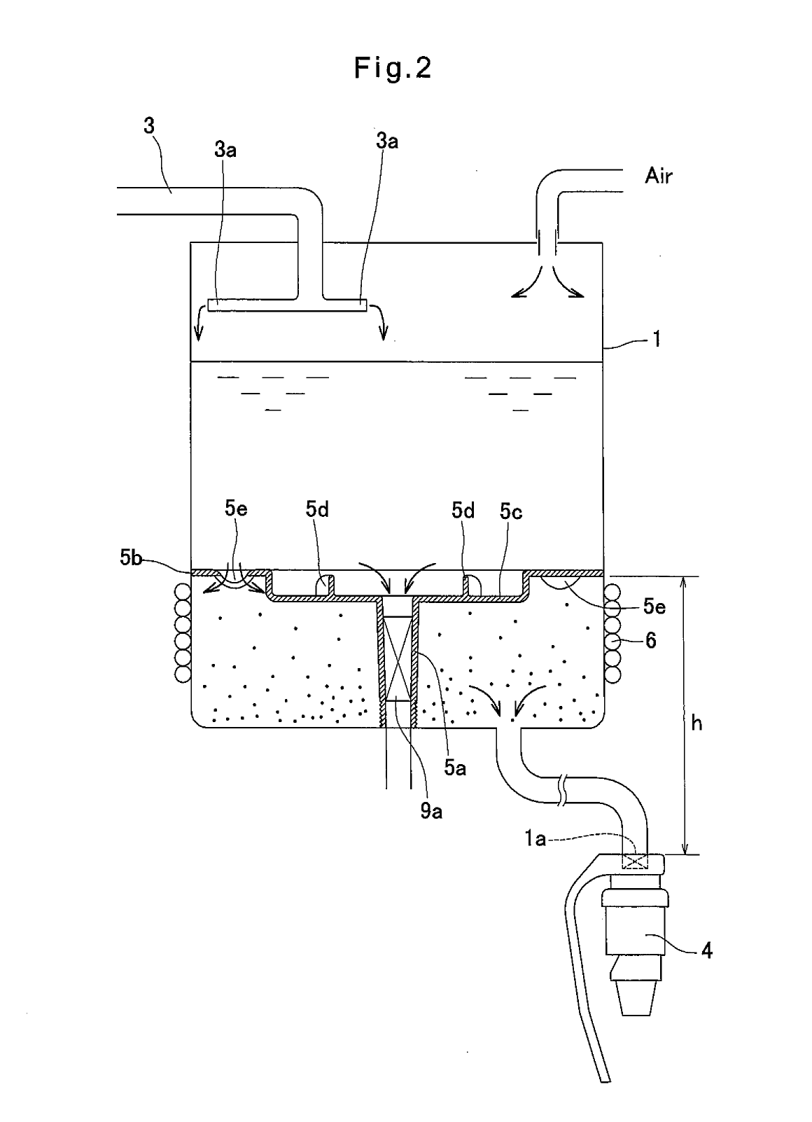

Now referring to the accompanying drawings, a water server embodying the present invention is described. As shown in FIGS. 1 and 2, this water server includes a cold water tank 1 which cools water stored therein, a water supply line 3 through which water is supplied from a raw water container 2 into the cold water tank 1, a cold water discharge line 4 extending from the cold water tank 1 to the atmosphere, and a baffle 5 which interferes with the downward flow of water introduced into the cold water tank 1 from the water supply line 3. Water in the raw water container 2 is fed into the cold water tank 1 through the water supply line 3, and water in the cold water tank 1 is cooled by a heat exchanger 6 mounted to the cold water tank 1. When a user opens a valve (not shown), cold water in the cold water tank 1 is fed through the cold water discharge line 4 and discharged into the atmosphere.

The heat exchanger 6 cools water in the cold water tank 1 by cooling the wall of the cold water tank 1.

The raw water container 2 is an exchangeable container. The raw water container 2 can be detachably set in a lower drawer of a housing of the water server. Water may however be supplied to the cold water tank 1 from the public water supply.

The water supply line 3 is connected to the raw water container 2. Water in the raw water container 2 is drawn up through the water supply line 3 by a pump 7 and is discharged, in a shower or in droplets, into the cold water tank 1 through terminal ends 3a thereof located at a position higher than a predetermined upper limit water level in the cold water tank 1. Water in the raw water container 2 is supplied to the cold water tank 1 when a water level sensor detects that the water level in the cold water tank 1 is below a predetermined value. The raw water container 2 may be placed not at the lower portion of the housing but above the cold water tank 1. In this case, water in the raw water container 2 is fed by gravity into the cold water tank 1 through a shorter water supply line 3.

A user-operated on-off valve (shown schematically by phantom lines crossing each other in FIG. 2) is mounted in the cold water discharge line 4. Downstream of this valve, the cold water discharge line 4 has a discharge port through which water is discharged into the atmosphere.

The baffle 5 is detachably mounted to the cold water tank 1. The baffle 5 includes a vertical shaft portion 5a fixed to the bottom surface of the cold water tank 1. When the baffle 5 is removed, it is possible to clean the inner wall of the lower portion of the cold water tank 1 indicated by the letter h. The baffle 5 further includes a partition plate portion 5c extending horizontally from the vertical shaft portion 5a and having an outermost circumferential portion 5b. Only the partition plate portion 5c performs the function as the baffle 5, i.e. the function of interfering with the downward flow of water. The outermost circumferential portion 5b extends the entire circumference of the baffle 5 and is located on a single horizontal plane. If the baffle 5 is not fixed to the bottom surface of the cold water tank 1, the vertical shaft portion 5a may be omitted. The partition plate portion 5c is a plate member having no space extending through the partition plate portion in the vertical direction. During use, the outermost circumferential portion 5b is located closest to the inner wall of the cold water tank 1 and has the largest circumference of the baffle 5. Thus, the outermost circumferential portion 5b forms the horizontal outer limit portion of the baffle. The outermost circumferential portion 5b is sufficiently resistant to water pressure to be kept in engagement with the inner wall of the cold water tank 1 during use of the water server. Instead of keeping the outermost circumferential portion 5b in engagement with the inner wall of the cold water tank 1, the outermost circumferential portion 5b may be mounted such that a gap is defined between outermost circumferential portion 5b and the inner wall of the cold water tank 1 over the entire circumference. The gap has to be narrow enough that water discharged from the water supply line 3 does not flow into the gap in a straight line. With this arrangement, water above the baffle 5 can slowly flow down through the gap and reaches the portion of the inner wall of the cold water tank 1 where there is the heat exchanger 6.

The heat exchanger 6 is provided at the lower portion of the cold water tank 1 at the height range from the bottom 1a of the cold water tank 1 to the outermost circumferential portion 5b of the baffle 5. As used herein, the word “height” refers to the height measured from the ground level. The bottom 1a of the cold water tank 1 refers to the lowest portion of the inner wall of the cold water tank 1. In the example shown, the bottom 1a of the cold water tank 1 is the upstream surface of the valve body of the valve which isolates the cold water tank 1 from the cold water discharge line 4 when the valve is closed. In FIG. 2, the lower portion h of the cold water tank 1 is indicated by double-headed arrow. The lower portion h of the cold water tank is within the height range of h. In the lower portion h, a low-temperature water layer, which is lower in temperature than water above the baffle 5, is generated from the bottom 1a due to the water cooling effect by the heat exchanger 6 and the water flow interfering effect by the baffle 5. The dots in FIGS. 1 and 2 indicate that the larger the number of dots per unit area, the lower the water temperature.

Since the cold water discharge line 4 is connected to the bottom 1a of the cold water tank, i.e. the lowest point of the lower portion h the cold water tank, it is possible to discharge water forming the low-temperature water layer. The cold water discharge line 4 may not have to be connected to the cold water tank 1 at the same height of the bottom 1a, but is preferably connected to the cold water tank 1 at least at substantially the same height of the bottom 1a in order to discharge water forming the low-temperature water layer without a loss.

The water server further includes a warm water tank 8 configured to heat water introduced into the tank 8 from the cold water tank 1, a connecting line 9 through which water in the cold water tank 1 above the baffle 5 is fed into the warm water tank 8, and a warm water discharge line 10 extending from the warm water tank 8 to the atmosphere. A valve 9a (schematically shown by solid lines crossing each other in FIG. 2) is mounted in the vertical shaft portion 5a to isolate the connecting line 9 from the cold water tank 1 when the valve 9a is closed. With this arrangement, since water above the baffle 5, which is higher in temperature than water forming the low-temperature water layer, is supplied into the warm water tank 8 through the connecting line 9, water can be heated in the warm water tank 8 using less energy, even though water from the raw water container 2 is supplied only into the cold water tank and not into the warm water tank. By providing the heat exchanger 6 within a height range lower than the outermost circumferential portion 5b of the baffle 5, the heat exchanger 6 is not used to cool water above the baffle 5, thus further saving energy.

An external thread is formed on the outer periphery of the vertical shaft portion 5a of the baffle 5 at its lower portion, which external thread can be brought into threaded engagement with an internal thread formed in the bottom surface of the cold water tank 1. Grip portions 5d are formed on the top surface of the partition plate portion 5c which can be used to turn the baffle 5 to drive its vertical shaft portion into the bottom of the tank 1. If the water server has no warm water supply function, or if the connecting line 9 is connected to the partition plate portion 5c through e.g. a separate tube, the baffle 5 may be detachably placed on or hooked to a shoulder portion of the cold water tank 1, thereby omitting the vertical shaft portion 5a.

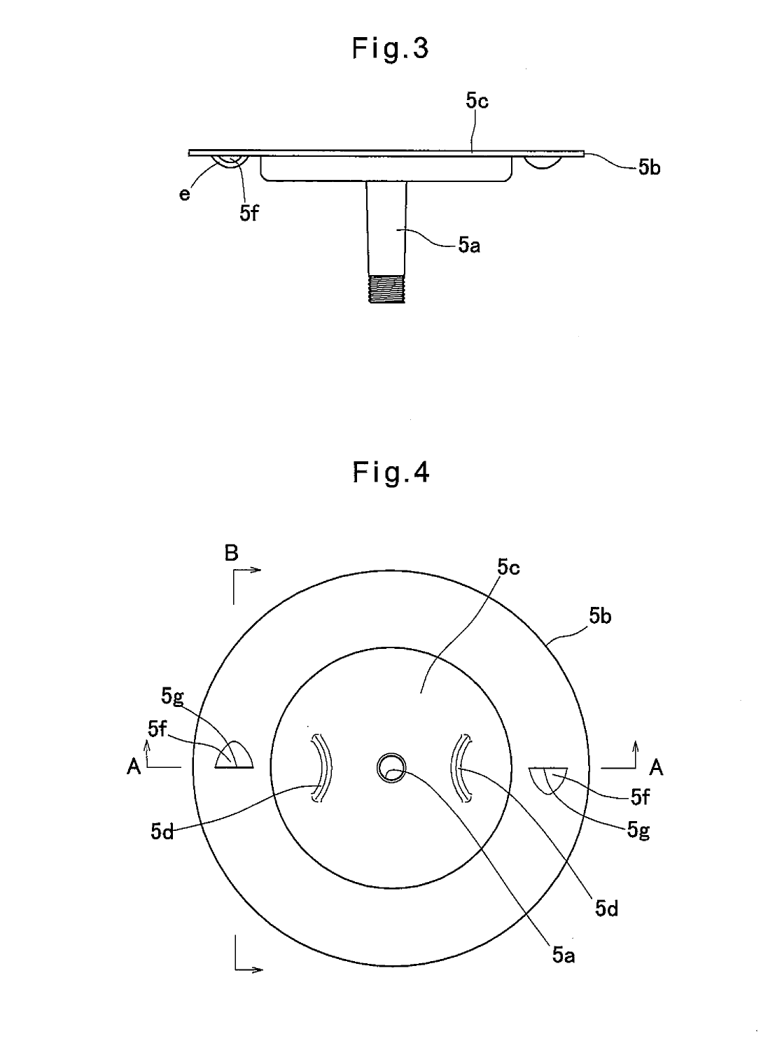

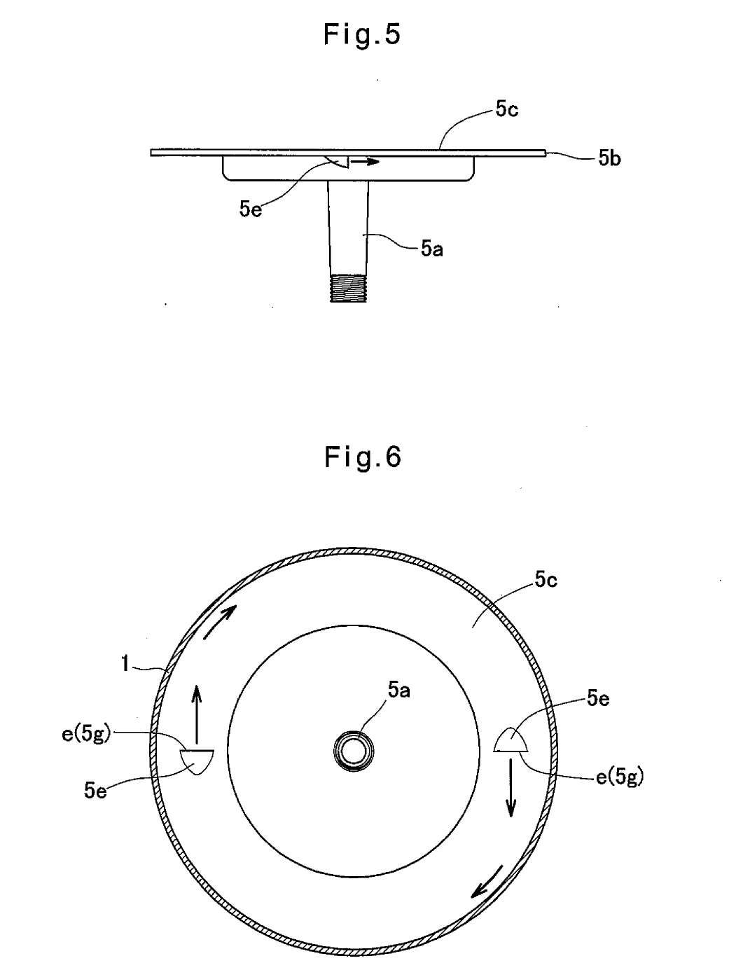

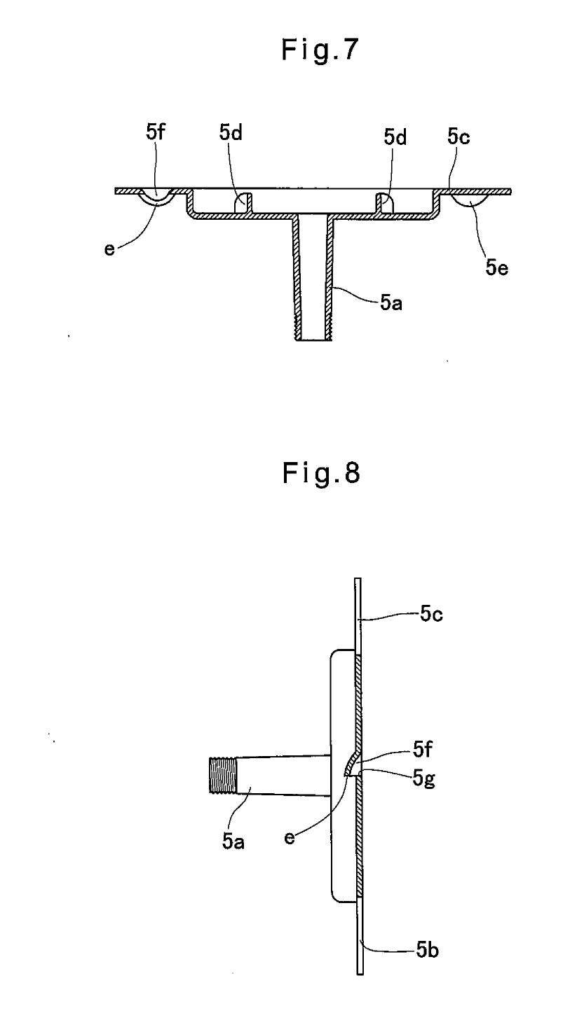

Water transfer passages 5e are formed in the baffle 5 at its portion radially inwardly of the outermost circumferential portion 5b. Through the water transfer passages 5e, water supplied onto the baffle 5 from the water supply line 3 flows into the lower portion h of the cold water tank. As shown in FIGS. 3 to 8, each of the water transfer passages 5e has no portion extending in the vertical direction over the entire vertical length thereof and is configured such that water is discharged into the lower portion h of the cold water tank in a horizontal direction or in a direction close to a horizontal direction. Once water is discharged from the water transfer passages 5e, water flows freely toward the low-temperature water layer, and it is impossible to control the flow direction e.g. neither in the vertically downward direction nor in a horizontal direction.

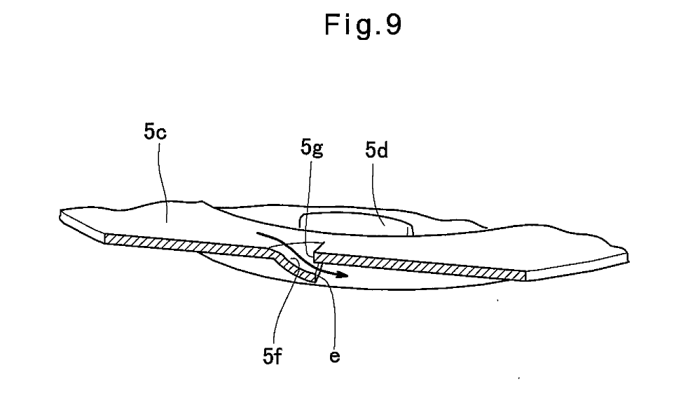

Each of the water transfer passages 5e comprises a downwardly recessed surface portion 5f formed on the top surface of the partition plate portion 5c of the baffle 5, and an edge portion 5g having a predetermined thickness and located over the distal edge e of the recessed surface portion 5f so as to overlap with the distal edge e. The distal edge e is the distal edge of the inner surface of the water transfer passage 5e and protrudes into the lower portion h of the cold water tank in the horizontal and downward directions. The edge portion 5g is formed when the recessed surface portion 5f is formed and has a vertical thickness equal the thickness of the partition plate portion at this portion. Each of the water transfer passages 5e has a terminal end opening defined by the distal edge e and the edge portion 5g and opens only in the direction perpendicular to a side view of the baffle 5. The recessed surface portion 5f is made up of a plurality of curved surfaces including inclined curved surfaces extending upstream from the distal edge e and inclined upwardly at angles of less than 45° relative to a horizontal plane and also inclined such that water flowing down along the recessed surface portion 5f collects to the central lowest portion of the recessed distal edge e. When water flows into each water transfer passage 5e from above the baffle 5, as shown by the arrow in FIG. 9, its flow is deflected by the recessed surface portion 5f, which has no portion extending vertically over the entire vertical length thereof, in a horizontal direction or a direction close to a horizontal direction by the time water reaches the terminal end opening defined by the distal edge e and the edge portion 5g. Water is thus discharged through the terminal end openings of the respective water transfer passages into the lower portion h of the cold water tank in a horizontal direction or a direction close to a horizontal direction. Since it is impossible to control the flow direction of water once water is discharged from the water transfer passages 5e, the baffle 5 is preferably configured such that water discharged from the water transfer passages maintains its flow direction when discharged for as long a distance as possible. For this purpose, the baffle 5 has no portion located at the same height as, and facing, the terminal end opening of any water transfer passage 5e. The recessed surface portion 5f may not comprise curved surfaces but may comprise tapered surfaces, flat surfaces, vertical surfaces, etc.

Water discharged from the water transfer passages 5e in a horizontal direction or a direction close to a horizontal direction has a larger horizontal speed component than the vertical speed component, so that such water never flows downwardly in the lower portion h of the cold water tank, shown in FIG. 2, in a straight line, but flows a longer distance in a horizontal direction than vertically downwardly. Water discharged from the water transfer passages 5e thus flows a longer distance until it is mixed into the low-temperature water layer, than water discharged downwardly toward the lower portion of the cold water tank. Therefore, the water server according to the present invention makes it more difficult for water discharged from the water transfer passages 5e to be mixed into the low-temperature water layer. In order to maximize the horizontal speed component of water discharged from the water transfer passages 5e, the water transfer passages 5e are arranged such that their terminal end openings substantially face horizontal directions.

The water transfer passages 5e may each comprise the partition plate portion 5c and a baffle forming component fitted on the partition plate portion 5c. With this arrangement, the water transfer passages 5e can be bent in a complicated manner, which makes it possible to reduce the flow speed of water by the time it reaches the terminal end openings.

As shown in FIGS. 3 to 8, the terminal end openings of all of the plurality of water transfer passages 5e face a single common direction of rotation about a common vertical axis. In the example shown, the vertical shaft portion 5a is the common vertical axis. With this arrangement, masses of water discharged from the respective water transfer passages 5e flow at the same height without colliding against each other. In particular, the masses of water flow down in the lower portion h of the cold water tank, shown in FIG. 2, while moderately whirling therein, as schematically shown by the arrows in FIG. 6. Thus, these masses of water flow a longer distance until they reach the low-temperature water layer, so that water discharged from the water transfer passages is never easily mixed into the low-temperature water layer.

In order to promote the whirling flow of water, the water transfer passages 5e are all arranged such that their terminal end openings face the cylindrical inner wall of the cold water tank 1 at the same height, with the cylindrical inner wall having a center axis coincident with the above-mentioned common vertical axis.

The baffle 5 shown in FIGS. 3 to 8 has only two water transfer passages 5e, and has a rotational symmetry of 180° about the common axis (except the external thread of the vertical shaft portion 5a). The baffle 5 is a single monolithic member. The water transfer passages 5e, which each comprises the recessed surface portion 5f and the edge portion 5g, can be formed simultaneously when forming the monolithic baffle 5 by an upper mold for forming the top surface of the baffle 5 and horizontally separable lower molds for forming the bottom surface of the baffle, without forming undercuts. The distal edges e of the recessed surface portions 5f, which are located under the edge portion 5g, are formed by the lower molds, which are split in the direction in which the two water transfer passages are arranged. The vertical shaft portion 5a, which are formed with the external thread on the outer periphery, can also be formed by the lower molds. The baffle 5 is thus made of an injection moldable synthetic resin. But instead, the baffle may be made of a metal, and/or formed by pressing. The line A-A of FIG. 4 includes a diameter line of the outermost circumferential portion 5b. The line B-B of FIG. 4 represents a vertical plane which divides one of the water transfer passages 5e into two portions that are mirror images of each other.

The number and the arrangement of water transfer passages 5e are not limited to those shown. For example, if the outermost circumferential portion 5b is fitted to the inner wall of the cold water tank 1, a larger number of water transfer passages 5e may be provided to increase the flow rate of water through the baffle to a required level. But if the number of water transfer passages 5e is increased, it may become difficult to extend the distance by which water flows while whirling. Thus, instead of increasing the number of water transfer passages 5e, the flow sectional area of each of the two water transfer passages 5e may be increased to increase the flow rate of water to the required level. The present invention is not limited to the above-disclosed embodiments but is to be understood to encompass all of the variations and modifications that are within the range of the attached claims.

### DESCRIPTION OF THE NUMERALS

1. Cold water tank
1a. Bottom
h. Lower portion of the cold water tank
2. Raw water container
3. Water supply line
4. Cold water discharge line
5. Baffle
5a. Vertical shaft portion
5b. Outermost circumferential portion
5c. Partition plate portion
5d. Grip portion
5e. Water transfer passage
5f. Recessed surface portion
5g. Edge portion
e. Distal edge
6. Heat exchanger

1. A water server comprising a cold water tank configured to cool water stored in the cold water tank, a water supply line through which water is supplied into the cold water tank, a cold water discharge line extending from the cold water tank to an atmosphere, and a baffle configured to interfere with a downward flow of water introduced into the cold water tank from the water supply line,
wherein the baffle has an outermost circumferential portion, wherein the cold water tank has a lower portion within a height range extending from a bottom of the cold water tank to the outermost circumferential portion, wherein the water server is configured such that a low-temperature water layer is generated in the lower portion of the cold water tank, the low-temperature water layer being lower in temperature than water in the cold water tank above the baffle, and such that water forming the low-temperature water layer is discharged through the cold water discharge line,
wherein the baffle is formed with at least one water transfer passage at a portion of the baffle located inwardly of the outermost circumferential portion such that water introduced into a portion of the cold water tank above the baffle can flow through the water transfer passage into the lower portion of the cold water tank,
wherein the water transfer passage has no portion extending in a vertical direction over an entire vertical length of the water transfer passage, and is configured such that water is discharged into the lower portion of the cold water tank from the water transfer passage in a horizontal direction or a direction close to a horizontal direction.

2. The water server of claim 1, wherein the at least one water transfer passage comprises a plurality of water transfer passages having terminal end openings which face a single common direction of rotation about a common vertical axis.

3. The water server of claim 1, wherein the at least one water transfer passage comprises a downwardly recessed surface portion formed on a top surface of the baffle and having a distal edge (e), and an edge portion having a predetermined thickness and located over the distal edge so as to overlap the distal edge.

4. The water server of claim 1, wherein each of the plurality of water transfer passages comprises a downwardly recessed surface portion formed on a top surface of the baffle and having a distal edge, and an edge portion having a predetermined thickness and located over the distal edge so as to overlap the distal edge.
